(19) United States
(12) Patent Application Publication
(10) Pub. No.: US 2025/0296139 A1
(43) Pub. Date: Sep. 25, 2025

(54) PLATE CARRYING MANIPULATOR FOR HIGH-SPEED STAMPING PRODUCTION LINE

(71) Applicants: JIER Machine-Tool Group Co.,Ltd., Jinan (CN); Jinan JIER Intelligent Equipment Co., Ltd., Jinan (CN)

(72) Inventors: Chuanying WANG, Jinan (CN); Dong WANG, Jinan (CN); Bing ZHAO, Jinan (CN); Xiangyu WANG, Jinan (CN); Xiuhua GAO, Jinan (CN); Teng ZHAO, Jinan (CN); Xianjin ZHAO, Jinan (CN)

(73) Assignees: JIER Machine-Tool Group Co.,Ltd., Jinan (CN); Jinan JIER Intelligent Equipment Co., Ltd., Jinan (CN)

(21) Appl. No.: 19/082,535

(22) Filed: Mar. 18, 2025

(30) Foreign Application Priority Data
Mar. 22, 2024 (CN) 202410335387X

(51) Int. Cl. B21D 43/10; B21D 22/02

(52) U.S. Cl. CPC B21D 43/105; B21D 22/02

(57) ABSTRACT

The present invention discloses a plate carrying manipulator for a high-speed stamping production line, belonging to the technical field of high-speed stamping production lines. The plate carrying manipulator includes two lifting devices, two swinging devices, a follower assembly, and an end effector, where each lifting device includes a lifting rack and a lifting sliding block; each swinging device includes a swinging frame and a rocker; the follower assembly includes a connecting rod connected to the end effector; and a sliding sleeve is rotatably mounted on the swinging frame. By controlling the lifting sliding block to perform lifting adjustment along the lifting rack, a vertical movement can be achieved; by controlling the swinging frames on two sides to swing, the sliding sleeve can be driven to swing; and by controlling the rocker to rotate, the connecting rod and the sliding sleeve can be driven to slide relative to each other.

### CROSS-REFERENCE TO RELATED APPLICATIONS

The application claims priority to Chinese patent application No. 202410335387X, filed on Mar. 22, 2024, the entire contents of which are incorporated herein by reference.

### TECHNICAL FIELD

The present invention belongs to the technical field of high-speed stamping production lines, and particularly relates to a plate carrying manipulator for a high-speed stamping production line.

### BACKGROUND

In automated production of manufacturing industry, manipulators are utilized to pick and place workpieces whether in stand-alone machines, combined machine tools, or automated production lines. The manipulator is an automatic device which mimics the movements of a human hand and implements automatic grabbing, carrying, and manipulation according to the given procedures, trajectories, and requirements. The control of the manipulator mainly involves position recognition, control of movement directions, and discrimination of the presence or absence of materials. Its task is to carry workpieces or objects from workstation A to workstation B.

Carrying manipulators are playing an increasingly important role in the manufacturing industry, especially in the field of transportation technologies for automated stamping production lines. High-speed stamping production lines are widely used in stamping processing of small precision parts such as those for precision electronics, communications, computers, household appliances, automobile parts, and stators and rotors of motors.

With the upgrading of the manufacturing industry, higher requirements have been put forward for the production efficiency and quality of the stamping production lines in such industry. Existing plate carrying manipulators for stamping production lines fail to achieve a satisfactory balance among operating stability, operating speed, and pick-and-place accuracy. This results in lower overall production efficiency of the stamping production lines, poor positioning accuracy of the manipulators, and manipulator shaking, leading to unreliable operation of the stamping production lines.

To meet the demand for fast, smooth, and accurate carrying of stamping parts on the high-speed stamping production lines, a plate carrying manipulator for a high-speed stamping production line is required.

### SUMMARY

In order to solve a problem that a conventional manipulator fails to achieve a satisfactory balance among operating stability, operating speed, and pick-and-place accuracy on a high-speed stamping production line, resulting in lower overall production efficiency of the stamping production line, poor positioning accuracy of the manipulator, and manipulator shaking, and further leading to unreliable operation of the stamping production line, the present invention provides a plate carrying manipulator for a high-speed stamping production line.

The present invention is achieved by the following technical solution:

A plate carrying manipulator for a high-speed stamping production line, including two lifting devices arranged opposite to each other, two swinging devices, a follower assembly, and an end effector capable of carrying a plate, where each lifting device includes a lifting rack capable of being positioned and mounted with an upright column of a press machine and a lifting sliding block capable of being mounted on an inner side of the lifting rack in a lifting-adjustable manner; each swinging device includes a swinging frame which is mounted to an inner side of the lifting sliding block in a rotatably adjustable manner, and a rocker is mounted on the swinging frame in a rotatably adjustable manner; the follower assembly includes a connecting rod which is rotatably connected and mounted to one end of the rocker away from the swinging frame, and one end of the connecting rod away from the rocker is connected to the end effector; and a sliding sleeve capable of slidably guiding the connecting rod is rotatably mounted on one end of the swinging frame away from the lifting sliding block.

As a further improvement of the present invention, transmission wheels are rotatably mounted at upper and lower ends of the lifting rack, and a transmission belt connected to the lifting sliding block is wrapped between two transmission wheels; a lifting sliding rail capable of vertically and slidably guiding the lifting sliding block is connected and mounted to the inner side of the lifting rack; and a first driving device in transmission connection with one of the transmission wheels is mounted on the lifting rack.

As a further improvement of the present invention, the first driving device includes a first stepper motor and a first speed reducer.

As a further improvement of the present invention, the first driving device is in transmission connection with an upper transmission wheel.

As a further improvement of the present invention, a third driving device capable of driving the swinging frame to swing is connected and mounted to one end of the swinging frame close to the lifting sliding block.

As a further improvement of the present invention, the third driving device includes a third stepper motor in transmission connection with the lifting sliding block.

As a further improvement of the present invention, a second driving device capable of rotatably driving the rocker is mounted on an inner side of a middle part of the swinging frame along a length direction of the swinging frame.

As a further improvement of the present invention, one end of the connecting rod close to the rocker is provided with a first connecting shaft which is rotatably connected and mounted to the rocker.

As a further improvement of the present invention, one end of the swinging frame away from the lifting sliding block is provided with a mounting base, and two sides of the sliding sleeve are provided with a second connecting shaft which is rotatably connected to the mounting base; a connecting rod sliding rail is mounted on the connecting rod along a length direction of the connecting rod, and a sliding sleeve sliding block in sliding fit with the connecting rod sliding rail is mounted on the sliding sleeve.

As a further improvement of the present invention, the end effector includes a cross rod capable of being mounted to one end of the connecting rod away from the rocker in a rotatably adjustable manner, and a clamping device capable of feeding and clamping the plate is mounted on the cross rod.

Through the above technical solutions, the present invention has the following beneficial effects:

By controlling the lifting sliding block to perform lifting adjustment along the lifting rack, a vertical movement of the end effector can be achieved; by controlling the swinging frames on two sides to swing, the sliding sleeve at end parts of the swinging frames can be driven to swing; and by controlling the rocker to rotate, the connecting rod and the sliding sleeve can be driven to slide relative to each other. Therefore, through a linkage action of the swinging frame, the sliding sleeve, the rocker, and the connecting rod, a movement position of the end effector can be accurately adjusted, a plate can be grabbed smoothly and accurately, a shaking phenomenon occurring in a high-speed movement process can be avoided, a “herringbone” moving trajectory (relatively short stroke) can be achieved, carrying speed and overall feeding efficiency can be improved, and operating reliability of the high-speed stamping production line can be ensured. The manipulator provided by the present invention is simple in overall structure, easy in implementation, and good in practicability.

### BRIEF DESCRIPTION OF THE DRAWINGS

To describe the technical solutions of the present invention more clearly, the following briefly introduces the accompanying drawings required for description. Apparently, the accompanying drawings in the following description show merely some embodiments of the present invention, and those of ordinary skill in the art may still derive other accompanying drawings from these accompanying drawings without creative efforts.

FIG. 1 is a schematic structural diagram of a specific implementation mode according to the present invention.

FIG. 2 is a schematic structural diagram of a lifting device of a specific implementation mode according to the present invention.

FIG. 3 is a schematic structural diagram of a swinging device of a specific implementation mode according to the present invention.

FIG. 4 is a schematic structural diagram of a follower assembly and an end effector of a specific implementation mode according to the present invention.

FIG. 5 is a schematic structural diagram of a swinging device, a follower assembly, and an end effector of a specific implementation mode according to the present invention.

FIG. 6 is a schematic diagram of a moving trajectory of a specific implementation mode according to the present invention.

In the figures: 1. lifting device, 101. lifting rack, 102. transmission belt, 103. lifting sliding block, 104. lifting sliding rail, 105. first driving device, 2. swinging device, 201. swinging frame, 202. rocker, 203. second driving device, 204. third driving device, 205. mounting base, 3. follower assembly, 301. first connecting shaft, 302. sliding sleeve, 303. connecting rod, 304. connecting rod sliding rail, 305. second connecting shaft, 4. end effector, 401. cross rod, 402. third connecting shaft.

### DETAILED DESCRIPTION OF THE EMBODIMENTS

To make the objectives, features, and advantages of the present invention more apparent and understandable, the following clearly and completely describes the technical solutions in the present invention with reference to the accompanying drawings in specific embodiments of the present invention. Apparently, the embodiments described below are some but not all of the embodiments of the present invention. Based on the embodiments in the present patent, all other embodiments obtained by those of ordinary skill in the art without making creative efforts shall fall within the protection scope of the present patent.

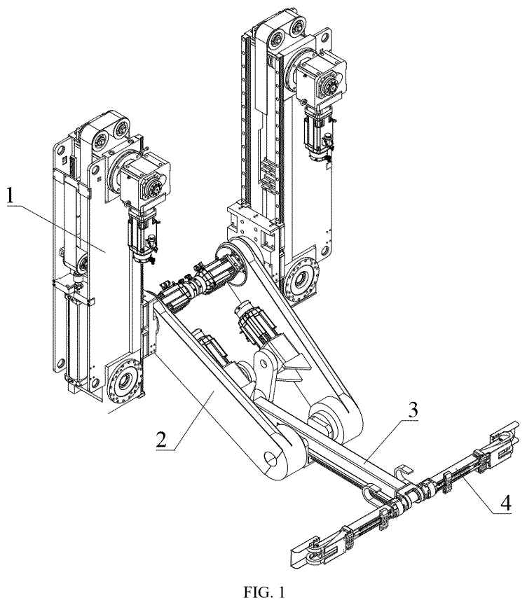

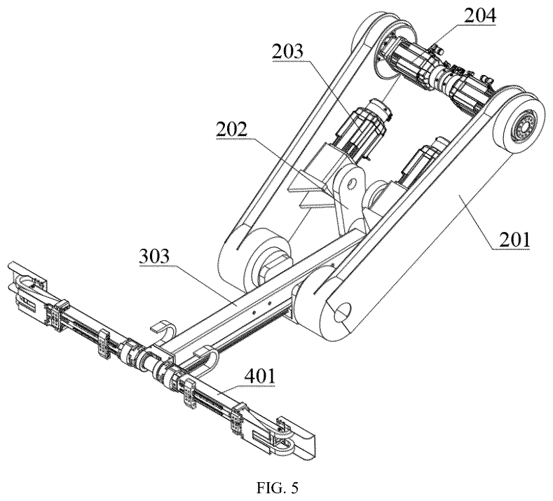

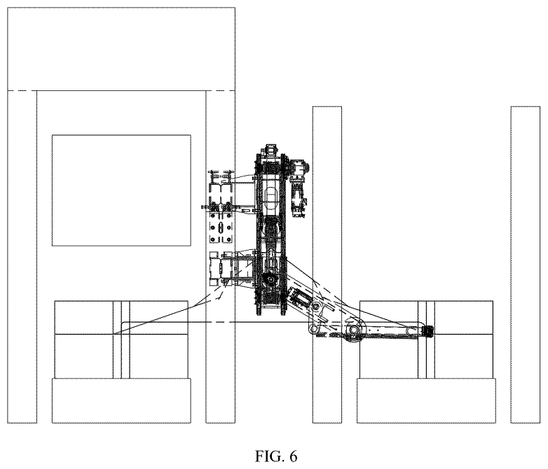

As shown in FIG. 1 to FIG. 6, the present invention discloses a plate carrying manipulator for a high-speed stamping production line, including two lifting devices 1 arranged opposite to each other at front and rear sides, two swinging devices 2, a follower assembly 3, and an end effector 4 capable of carrying a plate, where each lifting device 1 includes a vertical lifting rack 101 capable of being positioned and mounted with an upright column of a press machine and a lifting sliding block 103 capable of being mounted on an inner side of the lifting rack 101 in a lifting-adjustable manner; each swinging device 2 includes a swinging frame 201 which is mounted to an inner side of the lifting sliding block 103 in a rotatably adjustable manner, and a rocker 202 is mounted on the swinging frame 201 in a rotatably adjustable manner; the follower assembly 3 includes a connecting rod 303 which is rotatably connected and mounted to one end of the rocker 202 away from the swinging frame 201, and one end of the connecting rod 303 away from the rocker 202 is connected to the end effector 4; and a sliding sleeve 302 capable of slidably guiding the connecting rod 303 is rotatably mounted on one end of the swinging frame 201 away from the lifting sliding block 103. The two lifting devices 1 at front and back sides and the two swinging devices 2 are symmetrically mounted, respectively.

By controlling the lifting sliding block 103 to perform lifting adjustment along the lifting rack 101, a vertical movement of the end effector 4 can be achieved; by controlling the swinging frames 201 on two sides to swing, the sliding sleeve 302 at end parts of the swinging frames 201 can be driven to swing; and by controlling the rocker 202 to rotate, the connecting rod 303 and the sliding sleeve 302 can be driven to slide relative to each other. Therefore, through a linkage action of the swinging frame 201, the sliding sleeve 302, the rocker 202, and the connecting rod 303, a movement position of the end effector 4 can be accurately adjusted, a plate can be grabbed smoothly and accurately, a shaking phenomenon occurring in a high-speed movement process can be avoided, a “herringbone” moving trajectory (relatively short stroke) can be achieved, carrying speed and overall feeding efficiency can be improved, and operating reliability of the high-speed stamping production line can be ensured. The manipulator provided by the present invention is simple in overall structure, easy in implementation, and good in practicability.

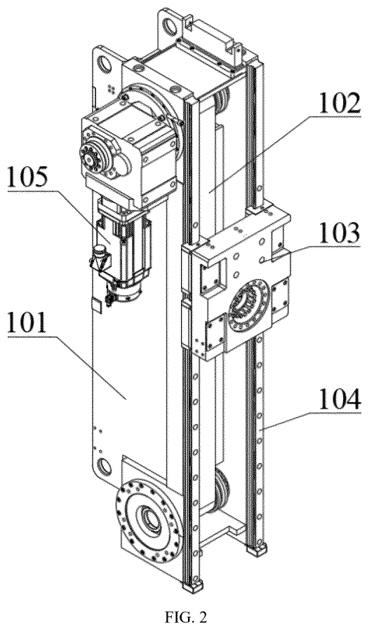

As shown in FIG. 2, transmission wheels are rotatably mounted at upper and lower ends of the lifting rack 101, and a transmission belt 102 connected to the lifting sliding block 103 is wrapped between two transmission wheels; a lifting sliding rail 104 capable of vertically and slidably guiding the lifting sliding block 103 is connected and mounted to the inner side of the lifting rack 101; and a first driving device 105 in transmission connection with one of the transmission wheels is mounted on the lifting rack 101. One of the transmission wheels is driven by the first driving device 105, and thus the lifting sliding block 103 is driven by the transmission belt 102 to perform lifting movement along the lifting sliding rail 104, thereby achieving stable, fast, and accurate lifting movement of the end effector 4.

Further, the first driving device 105 includes a first stepper motor and a first speed reducer, where the first speed reducer is a direction-changing speed reducer which ensures accuracy and stability in driving lifting of the lifting sliding block 103.

Further, the first driving device 105 is in transmission connection with an upper transmission wheel. The first driving device 105 (the first stepper motor and the first speed reducer) is mounted at an upper end of the lifting rack 101, thereby avoiding the first driving device from interfering with a path of feeding and clamping a plate by the end effector 4.

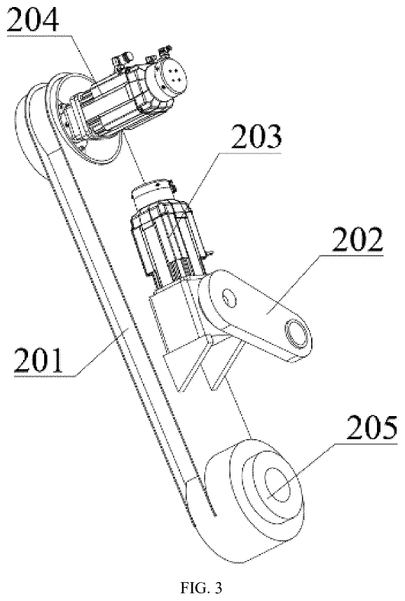

As shown in FIG. 3, a third driving device 204 capable of driving the swinging frame 201 to swing is connected and mounted to one end of the swinging frame 201 close to the lifting sliding block 103. The third driving device 204 includes a third stepper motor in transmission connection with the lifting sliding block 103. By controlling rotation of the third stepper motor, accurate and reliable swinging actions of the swinging frame 201 can be achieved.

As shown in FIG. 3, a second driving device 203 capable of rotatably driving the rocker 202 is mounted on an inner side of a middle part of the swinging frame 201 along a length direction of the swinging frame. The second driving device 203 includes a second stepper motor and a second speed reducer, where the second speed reducer is a direction-changing speed reducer. The second stepper motor and the second speed reducer are mounted on an inner side of the swinging frame 201 through a bracket and arranged along a length direction of the swinging frame 201, which can achieve compact arrangement of the second driving device 203; and rotatable driving of the rocker 202 can be accurately and stably achieved by the second driving device 203.

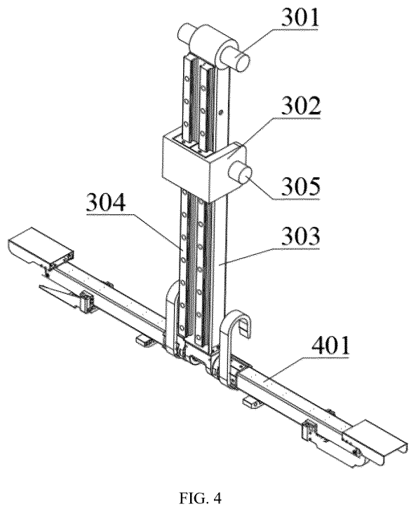

As shown in FIG. 4, one end of the connecting rod 303 close to the rocker 202 is provided with a first connecting shaft 301 which is rotatably connected and mounted to the rocker 202. By rotatably connecting and mounting the first connecting shaft 301 on two sides with the rocker 202 on two sides, reliable and stable driving of the connecting rod 303 can be achieved.

As shown in FIG. 3 to FIG. 4, one end of the swinging frame 201 away from the lifting sliding block 103 is provided with a mounting base 205, and two sides of the sliding sleeve 302 are provided with a second connecting shaft 305 which is rotatably connected to the mounting base 205; a connecting rod sliding rail 304 is mounted on the connecting rod 303 along a length direction of the connecting rod, and a sliding sleeve sliding block in sliding fit with the connecting rod sliding rail 304 is mounted on the sliding sleeve 302. By rotatably connecting and mounting the second connecting shaft 305 with the mounting base 205, and through slidable guiding and sliding fit of the sliding sleeve sliding block and the connecting rod sliding rail 304, the operating accuracy and stability of the end effector 4 at the end part of the connecting rod 303 can be achieved.

Further, the sliding sleeve 302 is of a channel steel structure, the connecting rod 303 is penetrated into a notch of the sliding sleeve, and the sliding sleeve sliding block is mounted on an inner side of a web plate of the sliding sleeve 302, so that the reliable sliding fit of the sliding sleeve 302 and the connecting rod 303 can be achieved.

The end effector 4 includes a cross rod 401 capable of being mounted to one end of the connecting rod 303 away from the rocker 202 in a rotatably adjustable manner, and a clamping device capable of feeding and clamping the plate is mounted on the cross rod 401. By driving the cross rod 401 to rotate through a fourth driving device, different molds and plates placed at different angles can be adapted, and the plate can be fed, clamped, and carried reliably by the clamping device.

The clamping device includes an electromagnet which can be mounted on the cross rod 401 in a slidably adjustable manner. By controlling power on or off of the electromagnet, a plate made of iron can be conveniently grabbed and placed.

According to the plate carrying manipulator for a high-speed stamping production line, by controlling the lifting sliding block 103 to perform lifting adjustment along the lifting rack 101, a vertical movement of the end effector 4 can be achieved; by controlling the swinging frames 201 on two sides to swing, the sliding sleeve 302 at end parts of the swinging frames 201 can be driven to swing; and by controlling the rocker 202 to rotate, the connecting rod 303 and the sliding sleeve 302 can be driven to slide relative to each other. Therefore, through a linkage action of the swinging frame 201, the sliding sleeve 302, the rocker 202, and the connecting rod 303, a movement position of the end effector 4 can be accurately adjusted, a plate can be grabbed smoothly and accurately, a shaking phenomenon can be avoided, a “herringbone” moving trajectory (relatively short stroke) can be achieved, carrying speed and overall feeding efficiency can be improved, and operating reliability of the stamping production line can be ensured. The manipulator provided by the present invention is simple in overall structure, easy in implementation, and good in practicability.

Various embodiments in the specification are described in a progressive manner, and each embodiment focuses on the differences from other embodiments, and the same or similar parts between the various embodiments can refer to each other.

The terms “upper”, “lower”, “outside”, “inside”, and so on (if any) in the specification and claims of the present invention and in the above accompanying drawing are intended to distinguish between relative relationships in position but do not indicate a qualitative description. It should be understood that the data used in this way can be interchanged where appropriate so that the embodiments of the present invention described herein may be implemented in an order other than those illustrated or described herein. In addition, the terms “including”, “having”, or any other variant thereof are intended for covering non-exclusive inclusions.

The above description of the disclosed embodiments enables a person skilled in the art to implement or use the present invention. Various modifications to these embodiments will be readily apparent to those skilled in the art, and the generic principles defined herein may be implemented in other embodiments without departing from the spirit or scope of the present invention. Therefore, the present invention is not intended to be limited to the embodiments shown herein, but is to be in accordance with the widest scope consistent with the principles and novel features disclosed herein.

What is claimed is:

1. A plate carrying manipulator for a high-speed stamping production line, comprising two lifting devices (1) arranged opposite to each other, two swinging devices (2), a follower assembly (3), and an end effector (4) capable of carrying a plate, wherein each lifting device (1) comprises a lifting rack (101) capable of being positioned and mounted with an upright column of a press machine and a lifting sliding block (103) capable of being mounted on an inner side of the lifting rack (101) in a lifting-adjustable manner; each swinging device (2) comprises a swinging frame (201) which is mounted to an inner side of the lifting sliding block (103) in a rotatably adjustable manner, and a rocker (202) is mounted on the swinging frame (201) in a rotatably adjustable manner; the follower assembly (3) comprises a connecting rod (303) which is rotatably connected and mounted to one end of the rocker (202) away from the swinging frame (201), and one end of the connecting rod (303) away from the rocker (202) is connected to the end effector (4); and a sliding sleeve (302) capable of slidably guiding the connecting rod (303) is rotatably mounted on one end of the swinging frame (201) away from the lifting sliding block (103).

2. The plate carrying manipulator for a high-speed stamping production line according to claim 1, wherein transmission wheels are rotatably mounted at upper and lower ends of the lifting rack (101), and a transmission belt (102) connected to the lifting sliding block (103) is wrapped between two transmission wheels; a lifting sliding rail (104) capable of vertically and slidably guiding the lifting sliding block (103) is connected and mounted to the inner side of the lifting rack (101); and a first driving device (105) in transmission connection with one of the transmission wheels is mounted on the lifting rack (101).

3. The plate carrying manipulator for a high-speed stamping production line according to claim 2, wherein the first driving device (105) comprises a first stepper motor and a first speed reducer.

4. The plate carrying manipulator for a high-speed stamping production line according to claim 2, wherein the first driving device (105) is in transmission connection with an upper transmission wheel.

5. The plate carrying manipulator for a high-speed stamping production line according to claim 1, wherein a third driving device (204) capable of driving the swinging frame (201) to swing is connected and mounted to one end of the swinging frame (201) close to the lifting sliding block (103).

6. The plate carrying manipulator for a high-speed stamping production line according to claim 5, wherein the third driving device (204) comprises a third stepper motor in transmission connection with the lifting sliding block (103).

7. The plate carrying manipulator for a high-speed stamping production line according to claim 1, wherein a second driving device (203) capable of rotatably driving the rocker (202) is mounted on an inner side of a middle part of the swinging frame (201) along a length direction of the swinging frame.

8. The plate carrying manipulator for a high-speed stamping production line according to claim 1, wherein one end of the connecting rod (303) close to the rocker (202) is provided with a first connecting shaft (301) which is rotatably connected and mounted to the rocker (202).

9. The plate carrying manipulator for a high-speed stamping production line according to claim 1, wherein one end of the swinging frame (201) away from the lifting sliding block (103) is provided with a mounting base (205), and two sides of the sliding sleeve (302) are provided with a second connecting shaft (305) which is rotatably connected to the mounting base (205); a connecting rod sliding rail (304) is mounted on the connecting rod (303) along a length direction of the connecting rod, and a sliding sleeve sliding block in sliding fit with the connecting rod sliding rail (304) is mounted on the sliding sleeve (302).

10. The plate carrying manipulator for a high-speed stamping production line according to claim 1, wherein the end effector (4) comprises a cross rod (401) capable of being mounted to one end of the connecting rod (303) away from the rocker (202) in a rotatably adjustable manner, and a clamping device capable of feeding and clamping the plate is mounted on the cross rod (401).
